(19) United States
(12) Patent Application Publication
(10) Pub. No.: US 2024/0057575 A1
(43) Pub. Date: Feb. 22, 2024

(54) DEEP WATER CRUSTACEAN HOOP NET

(71) Applicant: AMERICAN MAPLE INC., Gardena, CA (US)

(72) Inventor: Ben HONG, GARDENA, CA (US)

(21) Appl. No.: 18/236,901

(22) Filed: Aug. 22, 2023

Related U.S. Application Data
(60) Provisional application No. 63/400,009, filed on Aug. 22, 2022.

(51) Int. Cl. A01K 69/10

(52) U.S. Cl. CPC A01K 69/10

(57) ABSTRACT

A hoop net for deep water crab and lobster fishing includes a smaller upper double ring coupled to a larger lower double ring via lateral support beams, and covered by a net with an opening defined by the upper double ring, and further including a smaller inner double ring affixed to the bottom of the net and located centrally relative to the upper and lower double rings.

### CROSS REFERENCE TO RELATED APPLICATIONS

The present application claims priority to and the benefit of U.S. Provisional Application No. 62/400,858, filed Aug. 25, 2022, entitled “DEEP WATER CRUSTACEAN HOOP NET,” the disclosure of which is incorporated herein in its entirety by reference.

### FIELD OF THE INVENTION

The present disclosure is generally related to the fishing industry, and more specifically to traps and nets for catching crustaceans.

### BACKGROUND

Devices for catching crabs, lobsters, and other crustaceans tend to come in the form of large commercial crab and lobster pots, or smaller nets meant for shallow waters. These smaller nets are susceptible to instability in stronger currents and have limited capacity, such that they generally are not suitable for deep water crab and lobster fishing. For example, some Dungeness crab in the pacific can grow up to 12″ wide, making their capture in low capacity small nets inefficient and costly.

The strategy for trapping crabs is basically the same as the strategy for trapping any crustacean. Traditionally, fishermen have used ‘pots’ that are homemade wire cage traps. Pots may hold a bait cage that holds bait. Balt can range from chicken wings to fish carcasses. The smell of the bait lures the crab into the trap. Some cages are designed to retain crabs inside the cage. Other cages have holes that allow smaller crabs to escape. When the crab is inside the cage, fishermen remove the cage from the water.

A crab bait cage is usually constructed of metal, and can be heavy. Balt cages are about 3″×6″×6″. On the other hand, the bait cage allows a fisherman to conserve the bait and reuse the bait. Nets can also trap crabs and other crustaceans.

The crab ring or hoop net is more delicate than a cage trap but can also catch shellfish, lobster, and crabs. A hoop net is usually sold as a ‘Crab Net’. Hoop nets have a small inner metal hoop in the center supported by a nylon netting, or the like, which is secured to a larger outer metal hoop. The hoop net usually has a 32″ outer upper steel ring and 12″ inner lower ring. Mesh netting attaches the two hoops. A fisherman puts the net in the water and the net rests flat on the ocean bottom. When the trap rests on the ocean bottom, crabs congregate to the bait held in a bait cage at the center of the net. Periodically, the net is brought to the surface to see if it has caught any crabs. Fishermen attach rope and floats to the net so that they may leave and return to the float at a later time.

A hoop net catches crabs when crabs enter the net and a fisherman pulls the net out of the water while the crabs are inside the net. When a fisherman pulls the net out of the water, the hoop net forms a basket where the outer ring envelopes the inner ring where the crabs congregate. A ¼′″ nylon cord or the like of about 50-100′ length attaches the outer hoop to a float that bobs at the surface. A hoop net is about twelve to fourteen inches deep to prevent escape during retrieval. The bait cage is difficult to manage, and adds substantial weight and bulk to the net.

### BRIEF SUMMARY OF EMBODIMENTS

The present disclosure is directed towards a crustacean capture net. More specifically, the present disclosure relates to a hoop net for trapping lobster and crab in deep water and/or high current environments. Embodiments disclosed herein are designed to operate in deeper and rougher waters than traditional crab and lobster nets and traps. For example, in some embodiments, the hoop net forms a conical structure with angles that are generally steeper than traditional hoop nets and provides more volume to accommodate taller stature of larger crustaceans. Furthermore, increased weight and rigidity can be provided by incorporating a double-ringed frame to withstand higher currents and keep the hoop net stably positioned on a sea bed.

In some embodiments, the ringed frame includes a powder coating or vinyl coating to protect the frame from corrosion. The frame may be fabricated out of metal (e.g., steel), plastic, composite, wood, or other materials known in the art. In some embodiments, the coating is blue to provide some camouflage in deep water, low light environments.

Some embodiments of the hoop net incorporate top and bottom double ringed perimeter frames that are affixed together by multiple lateral support beams, wherein the top double ringed perimeter frame has a smaller diameter than the bottom double ringed perimeter frame as to form a conical rigid frame structure. The conical rigid frame structure is then covered by a net, and the top double ringed perimeter frame defines the opening for the net. A smaller ring is also affixed to the bottom of the net and located central to the bottom double ringed perimeter frame, such that when the hoop net is hoisted upward, the smaller ring weighs the center of the net downward to form an inverted conical shape extending below the conical rigid frame structure. In some embodiments, the hoop net is affixed to a three-legged rope bridal, that is then affixed to a rope to pull the hoop net up out of the water. A float may be located at the top of the three-legged bridal or on the rope.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention.

FIG. 1 illustrates a perspective view of an example hoop net, consistent with embodiments disclosed herein.

FIG. 2 illustrates an enlarged perspective view of a section of an example hoop net, consistent with embodiments disclosed herein.

FIG. 3 illustrates a perspective view of an example hoop net, consistent with embodiments disclosed herein.

FIG. 4 illustrates a perspective view of an example hoop net in a hoisted configuration, consistent with embodiments disclosed herein.

FIG. 5 is a diagram illustrating an example deployment of a hoop net, consistent with embodiments disclosed herein capsule.

FIG. 6 illustrates a top down view of an example hoop net, consistent with embodiments disclosed herein.

These figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present disclosure is directed towards a hoop net for catching crustaceans, such as crabs or lobsters, in deep water and/or heavy current environments. In some embodiments, the hoop net includes a first ring component abutted and mechanically affixed to a second ring component, wherein the first and second ring components each have a first diameter. For example, the first and second ring components may be welded, bolted, or screwed together. The hoop net may also include a third ring component abutted and mechanically affixed to a fourth ring component, wherein the third and fourth ring components each have a second diameter that is smaller than the first diameter. For example, the third and fourth ring components may be welded, bolted, or screwed together. Multiple lateral support beams mechanically affix the second ring component to the third ring component, such that the third and fourth ring components are spaced from and centrally positioned relative to the first and second ring components. For example, the ring components and the lateral support beams may be welded, bolted, or screwed together to form a rigid support frame that has a conical shape, with the first and second ring components forming a bottom of the rigid support frame and the third and fourth ring components forming a top of the rigid support frame. By welding two rings together to form the double ring structures at the top and bottom of the rigid frame, easy-to-manufacture and relatively inexpensive components may be used to form a more rigid, reinforced, and heavier structure capable of resting stably at the bottom of the sea floor under heavier currents and pressures.

In some examples, the ring components may be fabricated from metal, such as steel. In some examples, the ring components may be plastic or composite. The ring components may be circularly shaped. In other examples, the ring components may be elliptical, oval, egg, triangle, square, rectangular, pentagonal, hexagonal, or other polygonal shapes.

In some examples, the hoop net also includes a net to catch crustaceans affixed to the perimeter of the first, second, third, and fourth ring components to form a conical netted enclosure surrounding each of the ring components and the lateral support beams (i.e., the rigid support frame), the net having an opening formed by the central aperture of the third and fourth ring components. The hoop net may also include a fifth ring component with a third diameter, the third diameter being smaller than the second diameter, wherein the fifth ring component is affixed to the portion of the net centered within the first and second ring components and the net is sufficiently large to enable the fifth ring component to drop below the first and second ring components to form an inverted conical shape below the first and second ring components when the hoop net is hoisted upward. In some examples, the fifth ring component is also a double ring component, with both rings of the double ring component welded, screwed, or bolted together.

In some embodiments, the ring components and support beams are powder coated or covered in vinyl. In some examples, the powder coating or vinyl are blue to provide camouflage in a deep water environment.

In some examples, the net may be a 2″ square mesh net and may include 49 top double selvage meshes.

In some embodiments, the first diameter may be between about 30″ and about 40″ (for example, the first diameter may be about 36″). For purposes of this application, the term “about” means plus or minus 1″ or, in the case of angular measurements, plus or minus 1 degree. In some embodiments, the ring components each have a cross-sectional diameter of between about 0.75″ and about 1.25″ (for example, about 1″). In some embodiments, the second diameter may be between about 15″ and about 25″ (for example, about 19″). The lateral support beams may each have a length of between about 9″ and about 13″. In some examples, each lateral support beam may have a length of between about 10″ and about 12″ (for example, about 11″), and the angle formed between each support beam and the plane of the first and second ring components is between about 45 degrees and about 55 degrees (for example, about 48 degrees). The third ring component may be spaced about 9.5″ from the second ring component. In some examples, the net has a total depth of about 24″ when the hoop net is hoisted upward. The total weight of the hoop net may be between about 22 lbs and 30 lbs.

In some embodiments, the hoop net includes a retrieval rope affixed to a 3 arm bridle, the 3 arm bridle affixed to the third and fourth ring components. For example, the bridle may include a bridle float to float the bridle arms up and away from the third and fourth ring components when the hoop net is submerged in water. The bridle float may be fabricated with plastic.

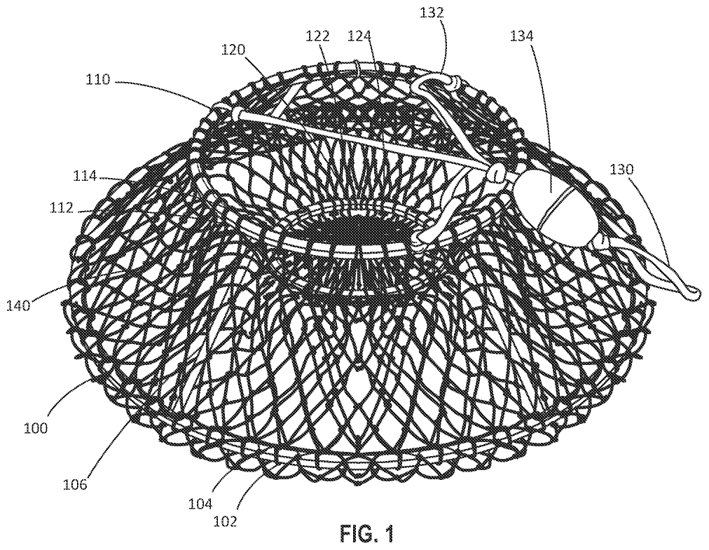

FIG. 1 illustrates a perspective view of an example hoop net, consistent with embodiments disclosed herein. Referring to FIG. 1, some embodiments of the hoop net include multiple single or double rings 100, 110, and 120, wherein single or double ring 100 connects to single or double ring 110 via multiple lateral support beams 106.

Single or double ring 100 may include a bottom ring 102 and a top ring 104 mechanically coupled together. In some examples, the mechanical coupling includes welding the rings together. In other examples, the rings may be bolted, clamped, screwed, riveted, snap fit, or strapped together. The rings may be fabricated from metal (e.g., steel or aluminum), plastic, wood, composite material, or other materials known in the art. In some examples, the rings may be hollow, solid, or filled with a weighting material such as lead, gel, concrete, sand, water, or oil. In some examples, instead of being a top and bottom ring, rings 102 and 104 may be side-by-side, with one being an inner ring and the other being an outer ring. In some embodiments, the rings have slightly different diameters.

In some embodiments, rings 102 and 104 have a diameter of between about 30″ and about 40″. In some embodiments, rings 102 and 104 have a diameter of about 36″. It should be appreciated that, although single or double ring 100 is shown in FIG. 1 as a circle, the ring could also be an oval, ellipse, triangle, square, pentagon, hexagon, or other polygon or amorphous ring. Rings 102 and 104 may have a cross-sectional diameters of between about 0.5″ and about 2″. In some embodiments, rings 102 and 104 have a cross-sectional diameter of about 1″. In some embodiments, rings 102 and 104 have a circular cross-section. In other embodiments, rings 102 and 104 have triangular, square, or rectangular cross-sections.

Lateral support beams 106 may be welded to single or double ring 100 (and specifically, top ring 104). In other examples, the lateral support beams 106 may be affixed to ring 104 via bolt, screw, bracket, rivet, or other mechanical connection as known in the art. Lateral support beams 106 may be fabricated from metal (e.g., steel or aluminum), plastic, wood, composite material, or other materials known in the art. In some examples, lateral support beams 106 are each between about 9″ and 13″ in length. In some embodiments, lateral support beams 106 are each about 11″ in length. Lateral support beams 106 may have a cross-sectional diameters of between about 0.5″ and about 2″. In some embodiments, lateral support beams 106 have a cross-sectional diameter of about 1″. In some embodiments, lateral support beams 106 have a circular cross-section. In other embodiments, lateral support beams 106 have triangular, square, or rectangular cross-sections. In some examples, the lateral support beams 106 may be hollow, solid, or filled with a weighting material such as lead, gel, concrete, sand, water, or oil. In some examples, the hoop net includes 6 lateral support beams 106. In other examples, the hoop net may have between 3 and 12 lateral support beams. The lateral support beams 106 may be evenly spaced around the hoop net. Alternatively, in some embodiments, the lateral support beams 106 may be spaced in groupings, with some support beams close together and others spaced further apart, so long as the support beams still form a symmetrical pattern around the perimeter of the hoop net.

Still referring to FIG. 1, double ring 110 may include a bottom ring 112 and a top ring 114 mechanically coupled together. In some examples, the mechanical coupling includes welding the rings together. In some example other examples, the rings may be bolted, clamped, screwed, riveted, snap fit, or strapped together. The rings may be fabricated from metal (e.g., steel or aluminum), plastic, wood, composite material, or other materials known in the art. In some examples, the rings may be hollow, solid, or filled with a weighting material such as lead, gel, concrete, sand, water, or oil. In some examples, instead of being a top and bottom ring, rings 112 and 114 may be side-by-side, with one being an inner ring and the other being an outer ring. In some embodiments, the rings have slightly different diameters.

In some embodiments, rings 112 and 114 have a diameter of between about 15″ and about 25″. In some embodiments, rings 112 and 114 have a diameter of about 19″. It should be appreciated that, although single or double ring 110 is shown in FIG. 1 as a circle, the ring could also be an oval, ellipse, triangle, square, pentagon, hexagon, or other polygon or amorphous ring. Rings 112 and 114 may have a cross-sectional diameters of between about 0.5″ and about 2″. In some embodiments, rings 112 and 114 have a cross-sectional diameter of about 1″. In some embodiments, rings 112 and 114 have a circular cross-section. In other embodiments, rings 112 and 114 have triangular, square, or rectangular cross-sections.

Lateral support beams 106 may be welded to single or double ring 110 (and specifically, bottom ring 112). In other examples, the lateral support beams 106 may be affixed to ring 112 via bolt, screw, bracket, rivet, or other mechanical connection as known in the art.

As illustrated in FIG. 1, single or double rings 100 and 110 mechanically and rigidly couple to lateral support beams 106 to form a rigid conical skeleton structure for the hoop net, with the larger ring 100 on the bottom and the smaller ring 110 on the top. In some examples, rings 100 and 110 are single rings. In some examples, only one of rings 100 and 110 is a double ring, and the other is a single ring. In some examples, either ring 100, 110, or both may include more than two rings mechanically coupled together. In some examples, ring 110 is spaced above ring 100 by between about 9″ and 10″. In some examples, ring 110 is spaced above ring 100 by about 9.5″. In some embodiments of the hoop net, the angle formed between each lateral support beam 106 and the plane of double ring 100 is between about 45 degrees and about 55 degrees. In one embodiment, the angle formed between each lateral support beam 106 and the plane of double ring 100 is about 48 degrees.

The rigid skeletal structure is covered by a net 140. Double ring 110 forms the opening aperture of the net 140, and the remainder of the net surrounds lateral support beams 106 and double ring 100, such that if a crustacean enters the hoop net through the aperture central to double ring 110, it will end up trapped inside of the hoop net. In some examples, the net 140 is a 2″ square mesh net. In some examples, net 140 includes 49 top double selvage meshes.

Still referring to FIG. 1, example hoop nets may also include a single ring or a double ring 120. In some examples, ring 120 includes rings 122 and 124 mechanically coupled together. In some examples, the mechanical coupling includes welding the rings together. In some example other examples, the rings may be bolted, clamped, screwed, riveted, snap fit, or strapped together. The rings may be fabricated from metal (e.g., steel or aluminum), plastic, composite material, or other materials known in the art. In some examples, the rings may be hollow, solid, or filled with a weighting material such as lead, gel, concrete, sand, water, or oil. In some examples, instead of being a top and bottom ring, rings 122 and 124 may be side-by-side, with one being an inner ring and the other being an outer ring. In some embodiments, the rings have slightly different diameters.

In some embodiments, rings 122 and 124 have a diameter of between about 8″ and about 10″. In some embodiments, rings 122 and 124 have a diameter of about 9″. It should be appreciated that, although single or double ring 120 is shown in FIG. 1 as a circle, the ring could also be an oval, ellipse, triangle, square, pentagon, hexagon, or other polygon or amorphous ring. Rings 122 and 124 may have a cross-sectional diameters of between about 0.5″ and about 2″. In some embodiments, rings 122 and 124 have a cross-sectional diameter of about 1″. In some embodiments, rings 122 and 124 have a circular cross-section. In other embodiments, rings 122 and 124 have triangular, square, or rectangular cross-sections.

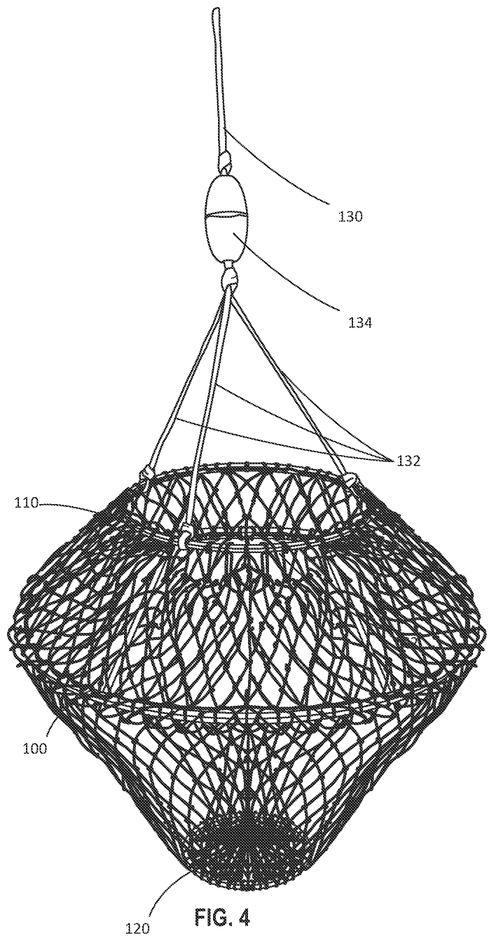

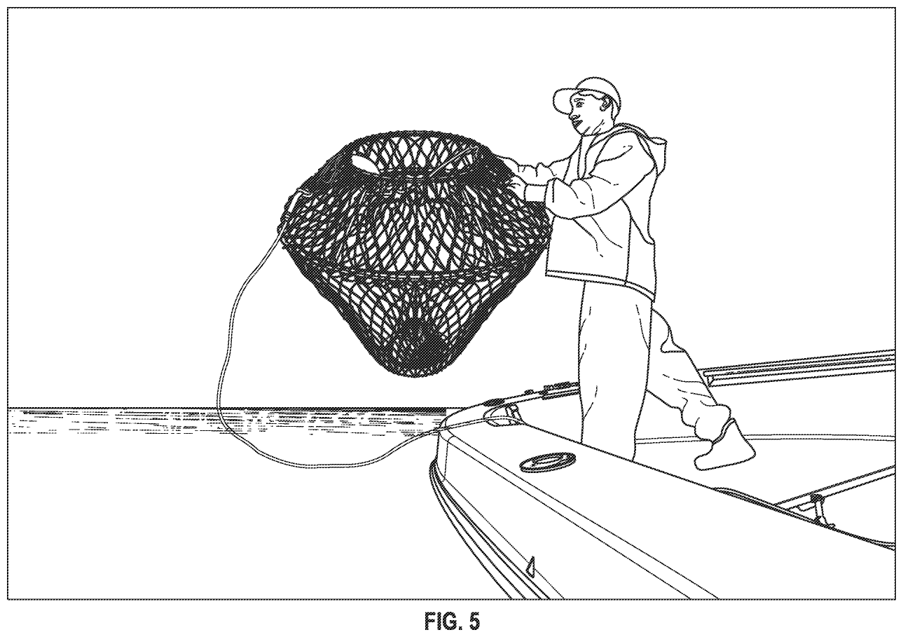

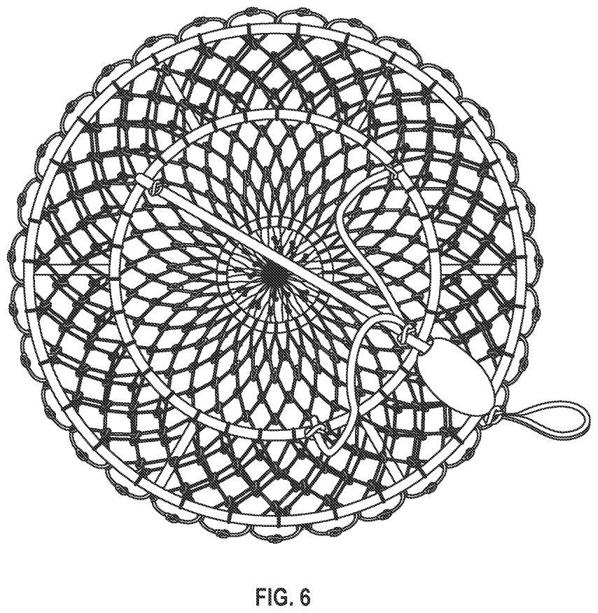

In some examples, ring 120 is affixed to net 140 in a position central to single or double ring 100, such that when the hoop net is hoisted as illustrated in FIGS. 4 and 5, ring 120 drops below double ring 100 to form an inverted conical shape. In some examples, the depth of the net when hoisted as illustrated in FIGS. 5 and 6 is between about 20″ and about 30″ from the top of double ring 110 and the bottom of ring 120. In one example, the depth of the net when hoisted is about 24″.

Some embodiments of the hoop net include a rope or cable 130 to hoist or lift the hoop net out of the water and deploy the hoop net into the water. The rope may attach to the hoop net through a bridal 132. Bridal 132 may be fabricated with rope or cable, and may have three or more legs to attach to double ring 110. In some examples, rope or cable 130 includes a float 134. In some embodiments, the float 134 is a polyplastic bridle float designed to float the bridle arms up and away from the top ring. Float 134 may be between about 4″ and 8″ long, and between about 2″ and 4″ in diameter. In other embodiments, float 134 is a spherical, ellipsoidal, or other shape as known in the art.

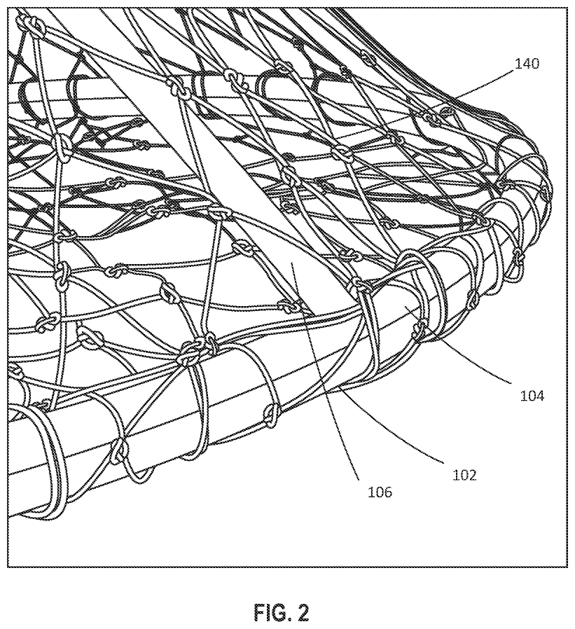

FIG. 2 illustrates an enlarged perspective view of a section of an example hoop net. As illustrated in FIG. 2, double top ring 104 abuts and mechanically couples to ring 102, and lateral support beam 106 mechanically couples to and extends upward from ring 104. As further illustrated in FIG. 2, net 140 couples to, and may be woven around rings 102 and 104.

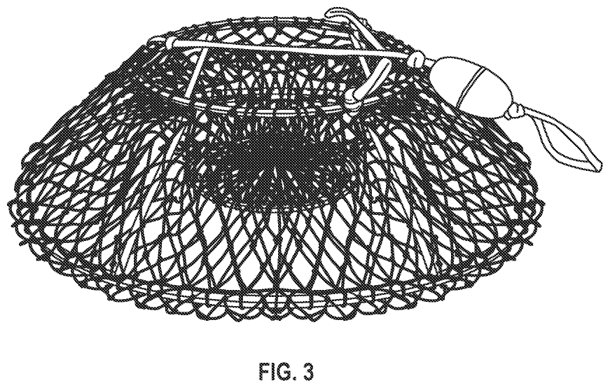

FIG. 3 illustrates a narrower perspective view of the example hoop net in an un-hoisted, or resting position. Conversely, FIG. 4 illustrates the example hoop net in a hoisted position with ring 120 dropped below double ring 100. As illustrated in FIG. 5, the hoisted position may be used when deploying the hoop net into the water, or when pulling the hoop net out of the water. In some examples, the added weight of the double rings creates stability for the hoop net on the sea floor.

Consistent with FIG. 5, in some embodiments, a method of crab or lobster fishing includes deploying a hoop net, as described in embodiments disclosed herein, into sea water to rest on the sea floor to form a volcano-shaped trap, waiting for a crab or lobster to enter the hoop net through the central aperture, and hoisting the hoop net upward by pulling a retrieval rope coupled to an arm bridle. The arm bridle may be coupled to the second ring component, wherein the hoisting the hoop net causes the third ring to drop below the first ring, forming an inverted conical section of the hoop net and trapping the crab or lobster therein.

FIG. 6 illustrates a top down view of an example hoop net. As can be appreciated from FIG. 6, rings 100, 110, and 120 are all located approximately symmetrically relative to one another.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A hoop net for deep water crab and lobster fishing, the hoop net comprising:
a first ring component abutted and mechanically affixed to a second ring component, wherein the first and second ring components each have a first diameter;
a third ring component abutted and mechanically affixed to a fourth ring component, wherein the third and fourth ring components each have a second diameter that is smaller than the first diameter;
multiple lateral support beams mechanically affixing the second ring component to the third ring component, such that the third and fourth ring components are spaced from and centrally positioned relative to the first and second ring components;
a net to catch a crab or a lobster affixed to the perimeter of the first, second, third, and fourth ring components to form a conical netted enclosure surrounding each of the ring components and the lateral support beams, the net having an opening formed by the central aperture of the third and fourth ring components; and
a fifth ring component with a third diameter, the third diameter being smaller than the second diameter, wherein the fifth ring component is affixed to the portion of the net centered within the first and second ring components and the net is sufficiently large to enable the fifth ring component to drop below the first and second ring components to form an inverted conical shape below the first and second ring components when the hoop net is hoisted upward.

2. The hoop net of claim 1, further comprising a sixth ring component abutted and mechanically affixed to the fifth ring component, wherein the sixth ring component has the same diameter as the fifth ring component.

3. The hoop net of claim 1, wherein the first, second, third, fourth and fifth ring components comprise steel, plastic, graphite, or composite material.

4. The hoop net of claim 1, wherein the first, second, third, fourth, and fifth ring components are powder coated.

5. The hoop net of claim 1, wherein the first diameter is between about 30″ and about 40″.

6. The hoop net of claim 1, wherein the first diameter is about 36″.

7. The hoop net of claim 1, wherein the first and second ring components are welded together and the third and fourth ring components are welded together.

8. The hoop net of claim 1, wherein the first, second, third, and fourth ring components each have a cross-sectional diameter of between about 0.75″ and about 1.25″.

9. The hoop net of claim 5, wherein the second diameter is between about 15″ and about 25″.

10. The hoop net of claim 6, wherein the second diameter is about 19″.

11. The hoop net of claim 9, wherein each support beam has a length of between about 9″ and about 13″.

12. The hoop net of claim 10, wherein each support beam has a length of between about 10″ and about 12″ and the angle formed between each support beam and the plane of the first and second ring components is between about 45 degrees and about 55 degrees.

13. The hoop net of claim 10, wherein each support beam has a length of about 11″ and the third ring component is spaced about 9.5″ from the second ring component, such that the angle formed between each support beam and the plane of the first and second ring components is about 48 degrees (+/−1 degree).

14. The hoop net of claim 1, wherein the net has a total depth of about 24″ when the hoop net is hoisted upward.

15. The hoop net of claim 1, wherein the total weight of the hoop net is between about 22 lbs and about 30 lbs.

16. A deep water crab and lobster fishing net, the net comprising:
a first ring with a first diameter;
a second ring with a second diameter that is smaller than the first diameter;
multiple lateral support beams mechanically affixing the first ring to the second ring, such that the first ring is spaced from and centrally positioned relative to the second ring component;
a net affixed to the perimeter of the first and second ring components to form a conical netted enclosure surrounding each of the first and second rings and the lateral support beams, the net having an opening formed by the central aperture of the second ring; and
a third ring with a third diameter, the third diameter being smaller than the second diameter, wherein the third ring is affixed to a portion of the net centered within the first ring and the net is sufficiently large to enable the third ring to drop below the first ring to form an inverted conical shape below the first ring when the net is hoisted upward.

17. The net of claim 16, further comprising six lateral support beams.

18. The net of claim 16, further comprising a retrieval rope affixed to a 3 arm bridle, the 3 arm bridle affixed to the second ring components.

19. The net of claim 16, further comprising a bridle float to float the bridle arms up and away from the third and fourth ring components when the hoop net is submerged in water.

20. A method of crab or lobster fishing using a hoop net, the method comprising:
deploying the hoop net into sea water to rest on the sea floor to form a volcano-shaped trap, wherein the hoop net comprises:
a first ring with a first diameter, a second ring with a second diameter that is smaller than the first diameter, multiple lateral support beams mechanically affixing the first ring to the second ring, such that the first ring is spaced from and centrally positioned relative to the second ring, a net affixed to the perimeter of the first and second rings to form a conical netted enclosure surrounding each of the first and second rings components and the lateral support beams, the net having an opening formed by the central aperture of the second ring, and a third ring with a third diameter, the third diameter being smaller than the second diameter, wherein the third ring component is affixed to a portion of the net centered within the first ring and rests on the sea floor while the hoop net is deployed;
waiting for a crab or lobster to enter the hoop net through the central aperture; and
hoisting the hoop net upward by pulling a retrieval rope coupled to an arm bridle, the arm bridle coupled to the second ring, wherein the hoisting the hoop net causes the third ring to drop below the first ring, forming an inverted conical section of the hoop net and trapping the crab or lobster therein.
